(19) United States
(12) Patent Application Publication
(10) Pub. No.: US 2008/0314885 A1
(43) Pub. Date: Dec. 25, 2008

(54) System and Method for Battery-Assisted, Engine-Driven Welding-Type Process

(76) Inventor: Richard Hutchison, Iola, WI (US)

Correspondence Address: QUARLES & BRADY LLP, 411 E. WISCONSIN AVENUE, SUITE 2040, MILWAUKEE, WI, 53202-4497, US

(21) Appl. No.: 11/766,555

(22) Filed: Jun. 21, 2007

(51) Int. Cl. B23K 9/10; B23K 9/32

(52) U.S. Cl. 219/133

(57) ABSTRACT

A welding-type system and method for providing supplemental output power in an engine-driven, welding-type system. The welding-type system includes a battery, an engine, and a generator coupled to the engine to be driven to generate a power. The system also includes a power conditioning circuit configured to convert the power generated by the generator to a primary welding-type power and an output configured to deliver the welding-type power to drive a welding-type process during a first state and a second state of the welding-type process. The system further includes a controller configured to monitor the welding-type process and selectively couple the battery to the output during the second state of the welding-type process to provide a supplemental welding-type power to drive the welding-type process during the second state of the welding-type process.

### REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to a welding-type system and, more particularly, to a system and method for providing supplemental power for a welding-type process driven by an engine-driven, welding-type system using battery.

Traditional welding-type apparatus can be broken into two basic categories. The first category receives operational power from transmission power receptacles, also known as static-power welding systems. The second is portable or self-sufficient, stand-alone welders having internal combustion engines, also known as rotating power welding systems or engine-driven welding systems. These engine-driven welders operate by utilizing power generated from operation of an engine and associated generator.

While, in many settings, conventional static-power driven welders are preferred, engine-driven welders enable welding-type processes where static power is not available and/or when a high degree of portability is desired. However, these engine-driven welding systems are generally less flexible than static-power welders with respect to the range of power and power characteristics that can be provided to drive a specific welding-type process. That is, engine-driven welding systems are limited by the power-generating abilities of the engine and generator, whereas static-power welding systems have a virtually unlimited source of power.

The limitations of an engine-driven welding system can become evident, for example, when performing a metal inert gas (MIG) welding process using a relatively large diameter wire and a short-circuit or modified short-circuit transfer process. During such a process, the consumable wire electrode is driven toward the weld location and periodically fuses to the workpiece to create a “short” between the welding torch and the grounded workpiece. To properly perform such a process, following each short, sufficient current must be delivered by the welding-type power supply to burn through the short and disconnect the consumable electrode from the workpiece. Among other considerations, the amount of current required to disconnect the electrode from the workpiece is directly proportional to the diameter of the consumable electrode forming the short. Accordingly, when using a relatively large diameter wire, an engine-driven welding system may be required to rapidly deliver a current in excess of the capabilities of the engine/generator.

Therefore, it would be desirable to have a welding-type system that is both portable and capable of providing a wide range of power characteristics to drive a variety of welding-type process.

### BRIEF SUMMARY OF THE INVENTION

The present invention overcomes the aforementioned drawbacks by providing a system and method for providing supplemental, on-demand power for a welding-type process being driven by an engine-driven welding system.

In accordance with one aspect of the present invention, a welding-type system is disclosed that includes a battery, an engine, and a generator coupled to the engine to be driven to generate a power. The system also includes a power conditioning circuit configured to convert the power generated by the generator to a primary welding-type power and an output configured to deliver the welding-type power to drive a welding-type process during a first state and a second state of the welding-type process. The system further includes a controller configured to monitor the welding-type process and selectively couple the battery to the output during the second state of the welding-type process to provide a supplemental welding-type power to drive the welding-type process during the second state of the welding-type process.

In accordance with another aspect of the present invention, a welding-type power supply is disclosed that includes a battery, an engine, and a generator coupled to the engine to be driven to generate a power. The welding-type power supply further includes a power conditioning circuit configured to convert the power generated by the generator to a welding-type power to drive a welding-type process. In addition, welding-type power supply includes a controller configured to selectively couple the battery to the power conditioning circuit to provide a supplemental power to be delivered with the welding-type power during at least a portion of the welding-type process.

In accordance with yet another aspect of the present invention, a method of driving a welding-type process is disclosed that includes operating an engine coupled to a generator to provide a welding-type power to a welding output to drive the welding-type process. The method further includes selectively coupling a battery to the welding output during at least a portion of the welding-type process to provide a supplemental power in addition to the welding-type power to drive the welding-type process.

Various other features of the present invention will be made apparent from the following detailed description and the drawings.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a perspective view of a welding-type system in accordance with the present invention;

FIG. 2 is a schematic diagram of the power delivery components of the welding-type system of FIG. 1; and

FIG. 3 is a flow chart setting forth the steps for operating a welding-type system, such as illustrated in FIGS. 1 and 2.

### DETAILED DESCRIPTION OF THE INVENTION

The present invention is directed to a welding-type apparatus and, more specifically, to an engine driven welding-type power source. As one skilled in the art will fully appreciate, the hereinafter description of welding-type devices not only includes welders and welding-type system, but also includes systems such as induction heating and plasma cutting systems.

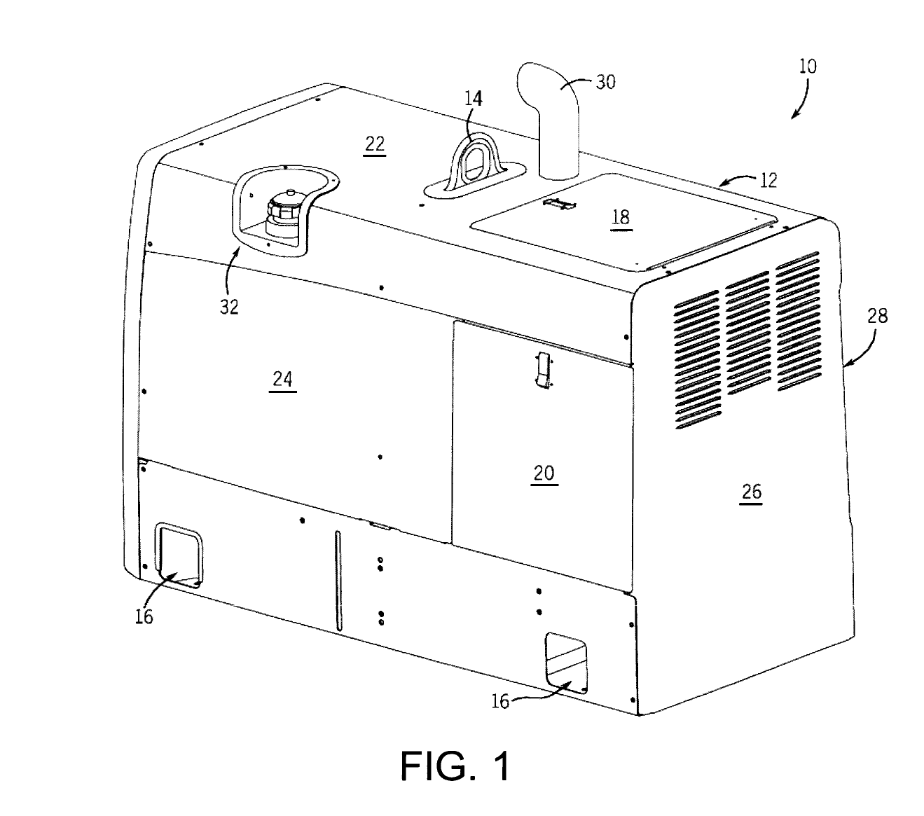

Referring now to FIG. 1, an engine-driven, welding-type system 10 includes a housing 12 that encloses the internal components of the welding-type power supply. Optionally, the welding-type system 10 includes a loading eyehook 14 and/or fork recesses 16. The loading eyehook 14 and the fork recesses 16 facilitate the portability of the welding-type device 10. Additionally, the welding-type system 10 may include a handle and/or wheels as a means of device mobility. The housing 12 also includes a plurality of access panels 18, 20. One access panel 18 provides access to a top panel 22 of the housing 12, while another access panel 20 provides access to a side panel 24 of the housing 12. Though not illustrated, a similar access panel is available on an opposite side. These access panels 18, 20, provide access to the internal components of the welding-type device 10 including, as will be described, an engine, generator, and energy storage device or battery that operate in concert to provide welding-type power.

An end panel 26 includes a louvered opening 28 to allow for air flow through the housing 12. Additionally, an exhaust port 30 is provided that extends above the top panel 22 of the housing 12 to vent exhaust generated by operation of the engine and a fuel port 32 is provided to deliver fuel for the engine through the housing 12. As illustrated, the fuel port 32 preferably does not extend beyond the top panel 22 or side panel 24. Such a construction protects the fuel port 32 from damage during transportation and operation of the welding-type system 10.

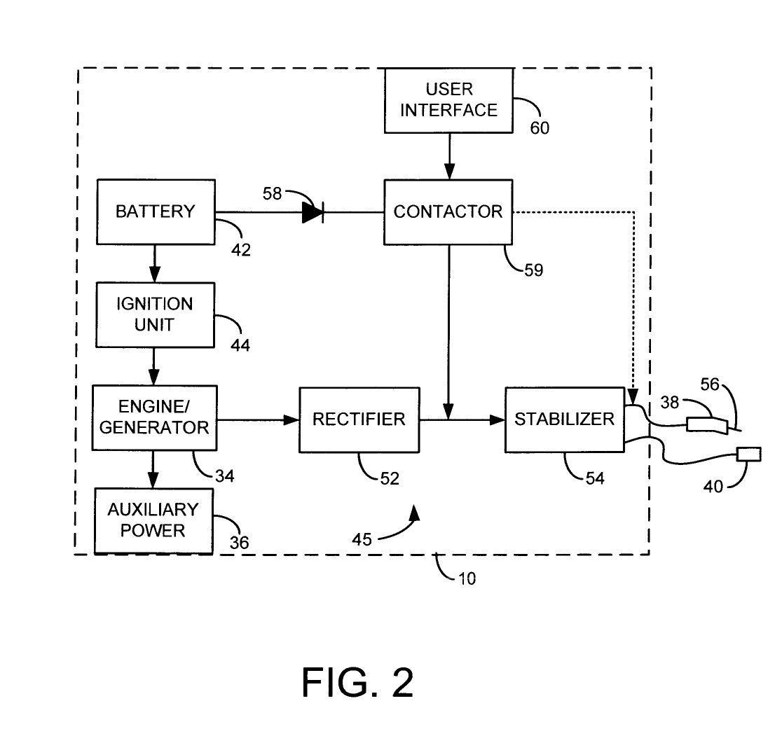

Referring now to FIG. 2, the engine-driven, welding-type system 10 includes an engine and generator 34 that form a primary power source for the engine-driven welding-type system 10. Specifically, the engine and generator 34 are configured to provide power to an auxiliary power output 36 and, as will be described, provide a primary or base welding-type power to perform a welding-type process using a welding torch 38 on a workpiece 40. A battery 42 or other energy storage device is included to provide power to an ignition unit 44 coupled to start the engine and generator 34 and also act as an on-demand, supplemental power source.

During operation of the engine and generator 34, power supplied by the generator is conditioned through a plurality of components, generally designated 45, to provide a welding-type power to the welding torch 38. Specifically, the conditioning components 45 generally include a rectifier 52, and a stabilizer 54. To this end, as is well-known in the art, the engine and generator 34 generate an AC power. The AC power is then provided to the rectifier 52 to convert the AC power to DC, welding-type power for use by the welding torch 38 to effectuate a welding-type process on the workpiece 40.

It is contemplated that the welding-type process may include a transfer mode commonly referred to as a short-circuit or modified, short-circuit transfer mode. In this case, a consumable wire electrode 56 is fed from the welding torch 38 toward the workpiece 40 and consumed as it is deposited on the workpiece 40. In the case of a short-circuit or modified short-circuit transfer mode, the consumable electrode 56 is deposited on the workpiece 40 by periodically driving the consumable electrode 56 to touch or “short” to the workpiece 40 and then disconnect the consumable electrode from the workpiece 40. This disconnection of the consumable electrode 56 from the workpiece 40 is effectuated by a rapid increase in the current delivered across the electrode 36 to the workpiece 40 due to the sudden drop in resistance caused by shorting the consumable electrode 56 to the workpiece 40. That is, the current drawn as a result of the short rapidly rises until it is sufficient to cause the short to break.

While engine driven welding-type power sources are commonly used to drive welding-type processes employing the short-circuit transfer mode, as described above, the effectiveness of the desired welding-type process is limited by the ability of the engine and generator 34 to meet the specific power characteristics required to effectuate a given welding-type process employing a short-circuit transfer mode. More particularly, the engine and generator 34 have a limited capacity to provide a given power characteristic. During a typical welding-type process, the arc voltage maintained between the consumable electrode 56 and workpiece 40 is approximately 18 volts. However, when employing a short-circuit transfer mode, the arc voltage drops to approximately 1 volt during the short period due to the rapid drop in resistance caused by the short. As described above, the short causes a rapid rise in current draw that continues until a short is broken. However, when utilizing an engine-driven welding-type system, the ability to provide the current required to break the short is limited by the characteristics of the engine and generator 34.

To supplement the abilities of the engine and generator 34 to meet the power delivery requirements under such conditions, the present invention employs the battery 42 as a supplemental power source. In particular, the battery 42 is connected through a diode 58 to provide a supplemental welding-type power to the welding torch 38 and electrode 56 during short conditions or other conditions that would benefit from supplemental power provided by the battery 42.

In operation, the diode 58 acts as a switch that keeps the battery 42 electrically isolated from the welding torch 38 and electrode 56 unless the arc voltage drops below the voltage of the battery 42. In this regard, the diode 58 acts as one controller that selectively couples and decouples the battery 42 to the welding torch 38 based on an operational state of the welding-type process being performed, which is indicated to the diode 58 by the voltage “seen” by the diode 58 between the electrode 56 and workpiece 40.

In the case of a 12 volt battery, as described above, the arc voltage remains well above the battery voltage, for example 18 volts, until a short occurs. The rapid voltage drop associated with the short condition causes the diode to allow current to flow from the battery 42 to the welding torch 38. More particularly, as soon as the arc voltage drops below that of the battery voltage, and a relatively negligible voltage drop associated with the diode 58, current flows from the battery 42, through the diode 58, and to the welding torch 38 to supplement the welding-type power delivered from the engine and generator 34. The ability of the battery 42 to provide almost instantaneous and very high current to the welding torch 38 to supplement the power delivered by the engine and generator 34 during a short condition enables the use of relatively large gauge electrodes 56 that would otherwise require current draws unobtainable or, at least rapidly unobtainable, by the engine and generator 34 to cleanly break the short.

It is contemplated that the battery 42 may be connected to provide power to the welding torch 38 at any of a variety of positions along the string of power conditioning devices 45. For example, it is contemplated that the battery 42 may be connected to the stabilizer 54 or directly to the welding output. Furthermore, it is contemplated that a contactor 59 may be provided to selectively decouple the battery 42 from the welding torch 38 during periods when the supplemental power supply provided by the battery 42 is unneeded or otherwise undesired. To this end, a user interface 60 is provided to allow a user to select whether the contactor 59 is closed or opened and, thereby, couple or decouple the battery 42 from the welding torch 38, respectively.

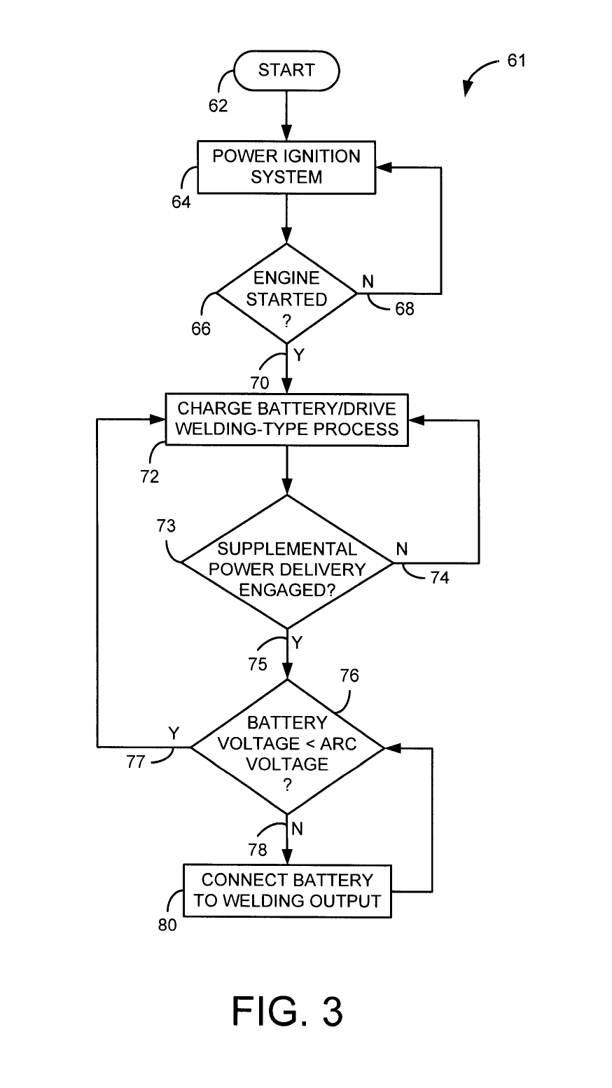

Referring now to FIG. 3, a process 61 for operating an engine-driven welding-type power source having a supplemental power supply configured to deliver a supplemental welding-type power, such as described above with respect to FIG. 2, is shown. The process 61 starts 62 upon a user engaging the ignition system of the engine-driven welding-type power source, whereby power is provided from a battery to power the ignition system 64. The process 61 continues by monitoring the engine to determine whether it has started 66. If the engine has not yet started 68, the battery continues to deliver power to the ignition system 64 to drive the engine through its start-up process. Once the engine has started 70, power is delivered back from the generator being driven by the engine to charge the battery and drive the desired welding-type process 72.

If the user has selected to disengage the ability to couple the battery to the welding output 73, 74, the engine and generator continue to be the sole source of power driving the welding-type process 72. However, if the user has selected to engage the ability to deliver supplemental power from the battery to drive the welding-type process 73, 75, as long as the battery voltage remains above that of the arc voltage 76, 77, the engine and generator continue to trickle-charge the battery while driving the welding-type process 72. On the other hand, once the arc voltage drops below the battery voltage 78, the battery is automatically connected to the welding output 80 to supplement the power provided by the engine and generator system. The battery continues to provide supplemental power to the welding output 80 until the battery voltage drops below that of the arc voltage 77, whereby the diode described above with respect to FIG. 2 disconnects the battery from the welding-type output and battery charging resumes 72.

Therefore, the above-described system and method are capable of providing supplemental, on-demand power for a welding-type process that is primarily driven by an engine-driven welding system. Specifically, an energy storage device, for example, a battery, is coupled to the welding output to provide supplemental power to the welding output during specific periods of the welding process, such as during short conditions. In this regard, the system utilizes the ability of the battery to meet the power requirements associated with rapid changes in output conditions and, thereby, provides a portable welding-type system that is highly versatile. Furthermore, by utilizing the battery designed to drive an electric-start ignition system of an engine-driven welder, the system can be provided without significantly increasing manufacturing costs and/or overall system complexity.

The present invention has been described in terms of the various embodiments, and it should be appreciated that many equivalents, alternatives, variations, and modifications, aside from those expressly stated, are possible and within the scope of the invention. Therefore, the invention should not be limited to a particular described embodiment.

We claim:

1. A welding-type system comprising:
a battery;
an engine;
a generator coupled to the engine to be driven to generate a power;
a power conditioning circuit configured to convert the power generated by the generator to a primary welding-type power;
an output configured to deliver the welding-type power to drive a welding-type process during a first state and a second state of the welding-type process; and
a controller configured to monitor the welding-type process and selectively couple the battery to the output during the second state of the welding-type process to provide a supplemental welding-type power to drive the welding-type process during the second state of the welding-type process.

2. The welding-type system of claim 1 wherein the primary welding-type power is delivered to the output to drive the welding-type process during both the first state and the second state and the supplemental welding-type power is only delivered to the output during the second state to supplement the primary welding-type power.

3. The welding-type system of claim 1 further comprising an ignition unit configured to drive the engine during a start-up process and wherein the battery is connected to the ignition unit to provide operational power to the ignition unit to drive the start-up process.

4. The welding-type system of claim 1 further comprising:
a contactor connected at a first end between the generator and the output and connected at a second end to the battery;
an output stabilizer connected between the first end of the contactor and the output; and
a user interface configured to control the contactor to act as an override to selectively decouple the battery from the output.

5. The welding-type system of claim 4 wherein the controller includes a diode arranged between the battery and the contactor to only allow current flow from the battery to the output.

6. The welding-type system of claim 1 wherein the controller is further configured to electrically isolate the battery from the output during the first state of the welding-type process.

7. The welding-type system of claim 1 wherein the supplemental welding-type power provides a current flow greater than a current flow provided by the primary welding-type power.

8. The welding-type system of claim 1 wherein the generator is further connected to the battery to provide a charging power to the battery.

9. The welding-type system of claim 1 wherein the welding-type process includes a metal inert gas (MIG) welding process.

10. The welding-type system of claim 1 wherein the second state is a short-circuit state and the first state is a non-short-circuit state.

11. A welding-type power supply comprising:
a battery;
an engine;
a generator coupled to the engine to be driven to generate a power;
a power conditioning circuit configured to convert the power generated by the generator to a welding-type power to drive a welding-type process; and
a controller configured to selectively couple the battery to the power conditioning circuit to provide a supplemental power to be delivered with the welding-type power during at least a portion of the welding-type process.

12. The welding-type power supply of claim 11 wherein the portion of the welding-type process includes a short-circuit period of the welding-type process.

13. The welding-type power supply of claim 11 further comprising a starter circuit configured to start operation of the engine to drive the generator and wherein the battery is connected to provide operational power to the starter circuit.

14. The welding-type power supply of claim 11 wherein the generator is further configured to provide a charging power to the battery.

15. A method of driving a welding-type process comprising:
operating an engine coupled to a generator to provide a welding-type power to a welding output to drive the welding-type process; and
selectively coupling a battery to the welding output during at least a portion of the welding-type process to provide a supplemental power in addition to the welding-type power to drive the welding-type process.

16. The method of claim 15 further comprising simultaneously operating the engine and generator to provide the welding-type power and a charging power to charge the battery.

17. The method of claim 15 further comprising closing and opening a switch to selectively couple the battery to the welding output.

18. The method of claim 15 wherein a current flow associated with the supplemental power is greater than a current flow associated with the welding-type power.

19. The method of claim 15 further comprising:
monitoring at least one operational characteristic of the welding-type power to identify a portion of the welding-type process when the engine and generator are unable to provide welding-type power having characteristics desired to drive the welding-type process; and
selectively coupling the battery to the welding output during the portion of the welding-type process when the engine and generator are unable to provide welding-type power having characteristics desired to drive the welding-type process to supplement the welding-type power to provide the characteristics desired to drive the welding-type process.

20. The method of claim 15 wherein the welding-type process is a MIG welding-type process and wherein the portion of the welding-type process includes a short-circuit period.
